(19) United States
(12) Patent Application Publication
(10) Pub. No.: US 2006/0259672 A1
(43) Pub. Date: Nov. 16, 2006

(54) Method, apparatus and computer program product providing device identification via configurable ring/multi-drop bus architecture

(75) Inventor: Juha Backman, Espoo (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/341,966

(22) Filed: Jan. 26, 2006

Related U.S. Application Data
(60) Provisional application No. 60/647,702, filed on Jan. 26, 2005.

(51) Int. Cl. G06F 13/00

(52) U.S. Cl. 710/110

(57) ABSTRACT

Disclosed is a method, an apparatus and a computer program product to assign different identification values to a plurality of devices coupled to a bus. The method includes detecting an edge of a bus signal in a first device, assigning to the first device an identification value based on a current value in a first device identification storage, sending a command to the next device, and other devices of the plurality of devices coupled to the bus, to increment the current value of their respective device identification storage; and closing a first device switch for coupling a next occurrence of the bus signal to a next device of the plurality of devices.

This patent application claims priority under 35 U.S.C. §119 (e) from Provisional Patent Application No.: 60/647,702, filed Jan. 26, 2005, the disclosure of which is incorporated by reference herein in its entirety.

### TECHNICAL FIELD

The presently preferred embodiments of this invention relate generally to communication bus architectures and topologies and, more specifically, relate to device architectures, including interfaces between a master or control unit and slave or peripheral devices, and between such devices.

### BACKGROUND

When multiple peripheral devices are connected to a control unit, such as an application engine, a need arises to identify individual ones of the devices by some means. In a simplest case there may be only one device connected to each port of the control unit, but in more complex architectures there are typically multiple devices connected to each port. The connected devices may also be physically similar or even identical (e.g., multiple instances of sensors, loudspeakers, amplifiers, etc.), so that identification by device type may not be sufficient. The use of permanent device identity numbers, dedicated identity pins, and similar means have limitations, as discussed below.

Referring to FIGS. 1A-1C there are illustrated simplified point-to-point, ring and multi-drop bus topologies, respectively, for interconnecting a plurality of devices. In the point-to-point case there may be single Master device and a plurality of slave devices (Slave_1 through Slave_n), while in the ring and multi-drop topologies there may be a plurality of peer devices (Device_1 through Device_n). It should be noted that in the ring and multi-drop topologies that one of the connected devices may assume the role of the bus master, and in some systems different devices may function as the bus master at different times.

The actual number of contact pins for the interface may vary, depending on the implementation. FIG. 1D shows a Table that summarizes certain characteristics of the basic bus topologies shown in FIGS. 1A-1C, including their advantages and disadvantages.

It is noted that in many applications of interest the use of the point-to-point topology, despite exhibiting otherwise attractive characteristics, is ruled out by the limited number of devices (expandability is low), whereas the more expandable topologies, ring and multi-drop, suffer from somewhat lesser limitations.

The use of unique device identity numbers, which may be proposed to solve the device addressing problem, have their own limitations, such as the problem of managing a potentially large number of unique identity numbers during manufacturing of the individual devices or components, defining the component identity numbers existing in a device, and providing in some embodiments a permanently writable memory area (flash, EPROM, etc.) to store the identity information.

Prior to this invention, no truly satisfactory solution was known by the inventor for solving these and other problems.

### SUMMARY OF THE PREFERRED EMBODIMENTS

The foregoing and other problems are overcome, and other advantages are realized, in accordance with the exemplary embodiments of this invention.

In one aspect thereof this invention provides a method to assign different identification values to a plurality of devices coupled to a bus, comprising detecting a change of state of a signal that occurs in a signal line in a first device; assigning to the first device an identification value based on a current value in a first device identification storage; sending a command to a next device, and other devices of the plurality of devices connected to the bus, to increment a current value of their respective device identification storage; and closing a switch in the first device for coupling another occurrence of the signal to the next device of the plurality of devices.

In another exemplary and non-limiting aspect thereof the invention provides a device that comprises means for detecting a change of state of a signal that occurs in a signal line input to the device from a bus; means for assigning to the device an identification value based on a current value contained in device identification storage; means for sending a command to a next device and to other devices coupled to the bus, the command being one to increment a current value of a respective device identification storage; and means for coupling another occurrence of the signal to a corresponding detecting means of the next device.

In a further exemplary and non-limiting aspect thereof this invention provides a computer program product embodied on a computer readable medium, execution of the computer program product by a processor resulting in operations comprising assigning different identification values to a plurality of devices coupled to a bus including detecting a change of state of a signal that occurs in a signal line in a first device; assigning to the first device an identification value based on a current value in a first device identification storage; sending a command to a next device, and other devices of the plurality of devices connected to the bus, to increment a current value of their respective device identification storage; and closing a switch in the first device for coupling another occurrence of the signal to the next device of the plurality of devices.

### BRIEF DESCRIPTION OF THE DRAWINGS

The foregoing and other aspects of the presently preferred embodiments of this invention are made more evident in the following Detailed Description of the Preferred Embodiments, when read in conjunction with the attached Drawing Figures, wherein:

FIGS. 1A, 1B and 1C illustrate simplified point-to-point, ring and multi-drop topologies, respectively, for interconnecting a plurality of devices;

FIG. 1D is a Table listing certain characteristics of the basic bus topologies shown in FIGS. 1A-1C;

FIG. 2 is a simplified schematic diagram showing the basic structure of a device connected to the configurable bus in accordance with embodiments of this invention;

FIG. 3 depicts an initial state of the devices connected to the bus of FIG. 2;

FIG. 4 shows the state of the devices connected to the bus of FIG. 2 after a first boot (initialization) step;

FIG. 5 shows the final state of the devices connected to the bus of FIG. 2 after completion of the boot phase;

FIG. 6 is a logic flow diagram that illustrates a method in accordance with the embodiments of this invention; and

FIG. 7 is a simplified block diagram of a wireless communications device constructed and operated in accordance with the embodiments of this invention.

### DETAILED DESCRIPTION OF THE PREFERRED EMBODIMENTS

In accordance with exemplary embodiments of this invention a certain bus interface pin or pins of a device connected to a multi-drop bus are configured to form a ring topology during a system boot procedure, hereafter referred to as a system initialization procedure, so that the physical location of the device on the bus can be identified. After the initialization procedure the bus topology reverts to an all multi-drop topology.

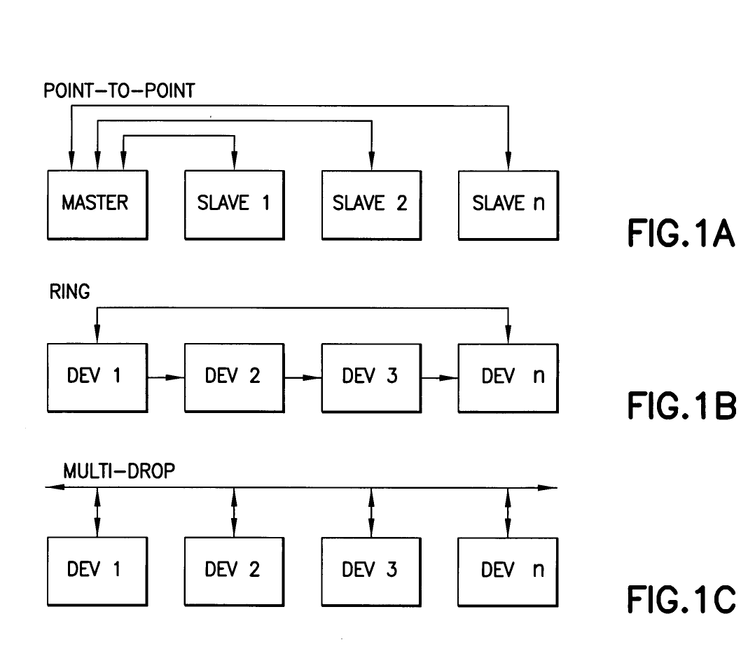

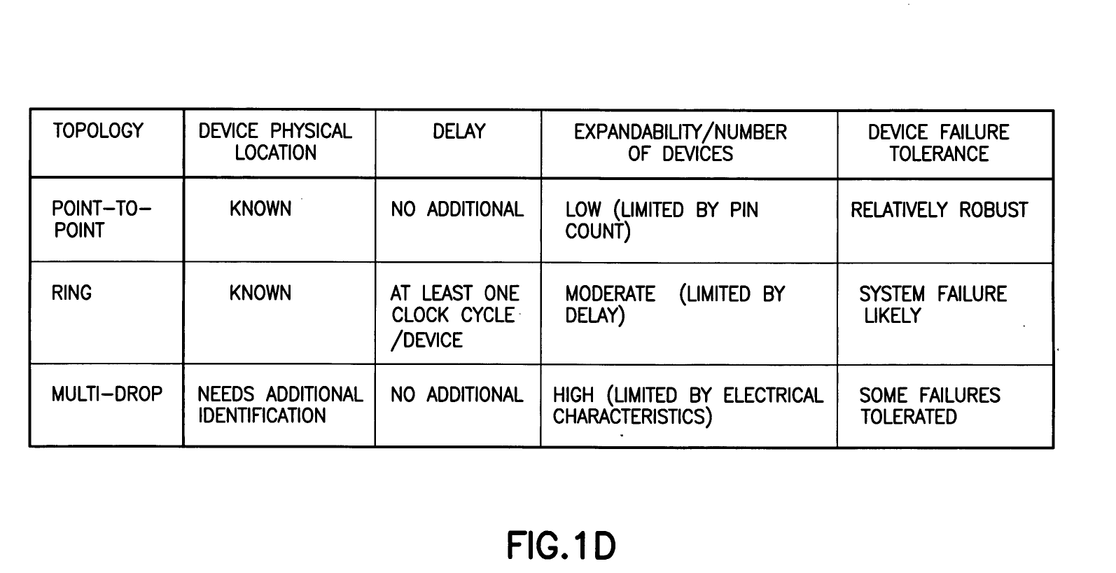

The inventor has realized that the ring bus topology discussed above and shown in FIG. 1B has a particular advantage during system initialization over the multi-drop bus topology, as the initialization sequence may be defined to automatically identify the locations of the individual devices. The exemplary embodiments of this invention exploit this feature, and provide a “mixed” bus architecture that automatically configures itself initially at least partially in the ring bus topology, and then sequentially reconfigures itself so as to function as an all multi-drop topology bus by the time the initialization sequence is completed.

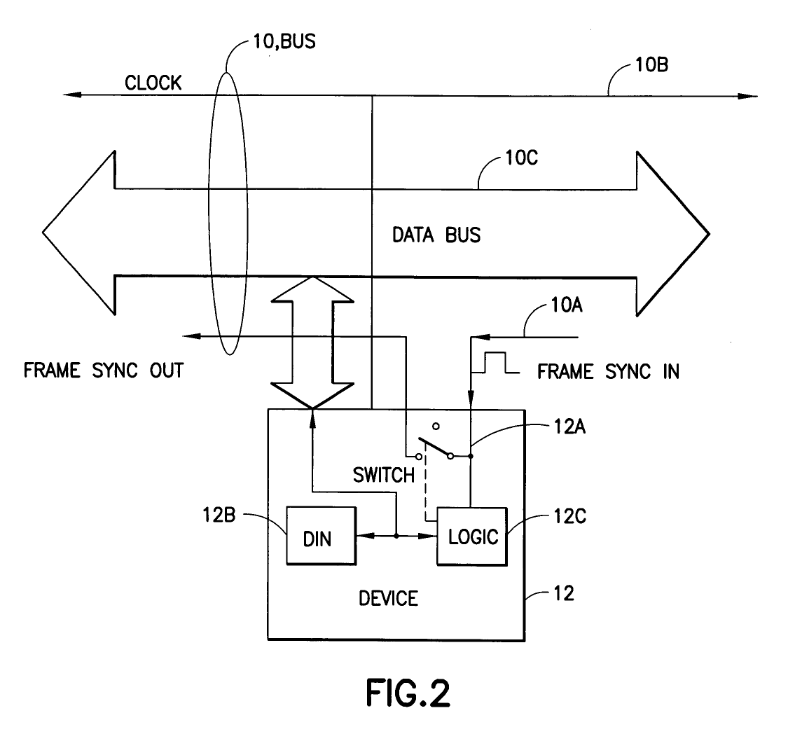

Referring to FIG. 2, in exemplary embodiments of this invention this desirable mode of operation is achieved by assigning at least one of the lines of a bus 10 to be connected to a simple, low delay switch 12A of a device 12. The bus line may be by example, and not as a limitation, a frame synchronization (frame sync) line 10A. The use of the frame sync signal line 10A simplifies the design of the bus protocol in general, although other signal lines could be used, as could a signal line dedicated just for the device number assignment function: The low-delay switch 12A operates so that when the device 12 is powered on, or is hard reset, the switch 12A is open (as shown in FIG. 2), and the switches 12A of connected devices 12 are closed sequentially during the initialization sequence. The switch 12A may be implemented with any suitable logical or electro-mechanical means including, but not limited to an AND gate, a simple transistor, or a Micro-Electro-Mechanical (MEMS) device. If an AND gate is used, for example, the frame sync signal line 10A can be coupled to a first input of the AND gate, and a second input of the AND gate is coupled to an enable/disable logic signal line, where a logic zero inhibits passage of the frame sync signal 10A through the AND gate (“opens” the switch 12A) and a logic one permits passage of the frame sync signal 10A through the AND gate (“closes” the switch 12A). Other equivalent type of logic gating can be used as well, such as an OR gate controlled by an enable signal line that is brought low to couple through the frame sync signal 10A. The activation time of the switch 12A is preferably less than a single cycle of a bus clock signal 10B. The device 12 preferably includes a counter or register 12B, or equivalent data storage structure, for storing a device identity number (DIN), which is defined during the initialization sequence as described below. A logic element 12C is also provided, as discussed below. Note that the device 12 may be embodied within an integrated circuit.

Bus 10 Initialization Sequence

The ensuing description assumes a power-on or power-up sequence, although those skilled in the art will recognize that a hard system reset event, without cycling the system power, will typically be functionally equivalent to a system power-up event. Reference is also made to the logic flow diagram of FIG. 6.

Step A: Power-up: reset all identity number registers 12B, open all frame sync switches 12A. FIG. 3 shows the initial state with all frame sync switches 12A open. Note that while the Master (Device_0) is depicted also as the source driving the clock signal line 10B, any device on the bus 10 may function as the clock source, or an external clock may be used. Preferably, but not as a limitation, there is only one clock active at a time.

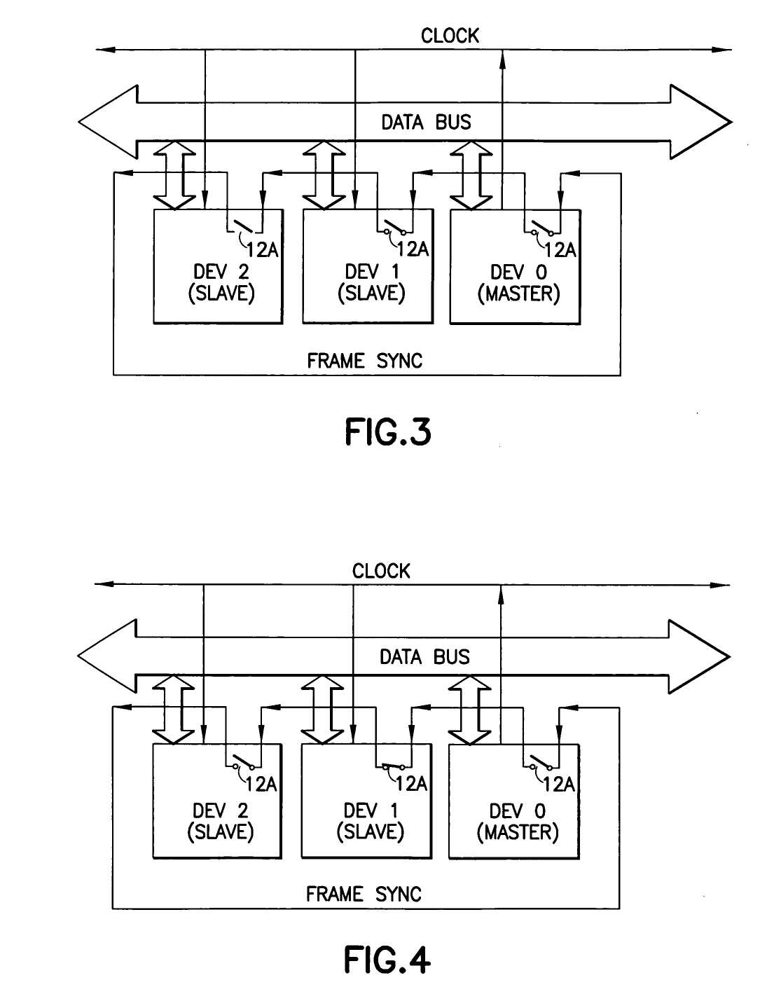

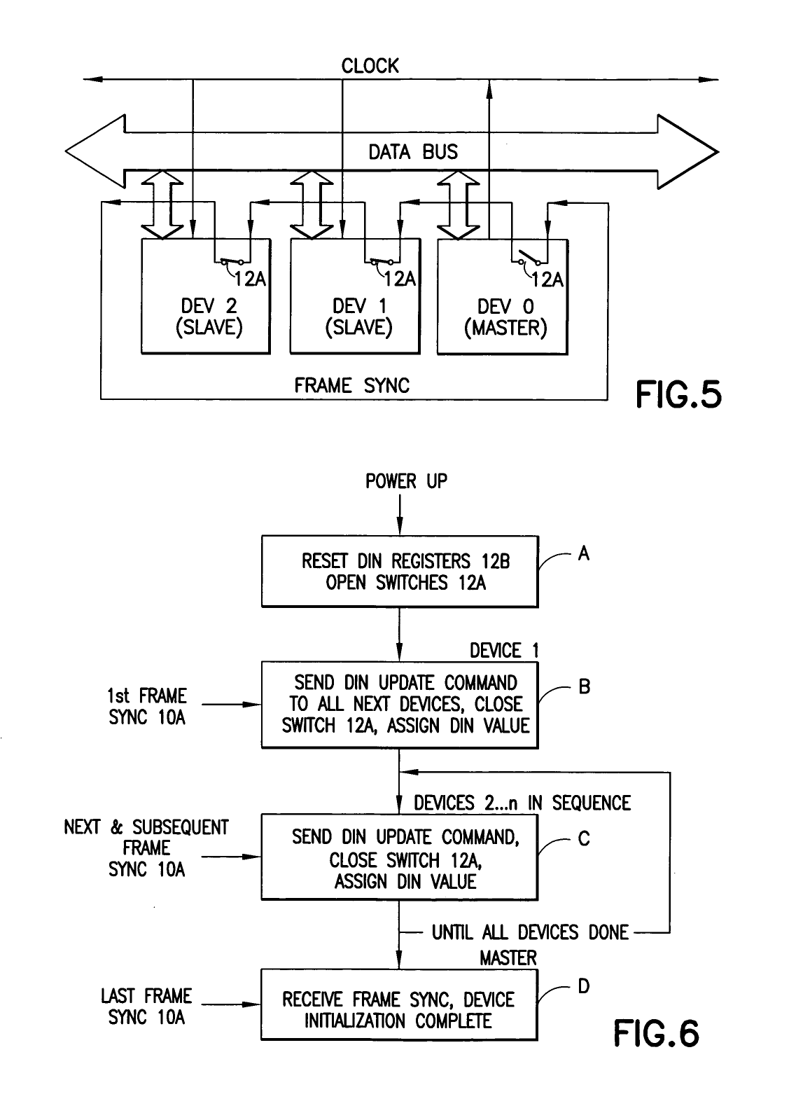

Step B: The Master device sends a frame sync signal (e.g., a frame sync pulse) to the first device (Device_1). Device_1 recognizes the frame sync pulse using the logic 12C (shown in FIG. 2) that is connected preferably before the wiper of the switch 12A, and assigns itself the first device number (e.g., zero). The logic 12C then sends, through data bus 10C, a message (DIN Update) to all other connected devices 12 to increment their DIN counters or registers 12B by one. The frame sync switch 12A is then closed by the logic 12C at or soon after the falling (or rising) edge of the frame sync pulse on the frame sync line 10A. FIG. 4 shows the system state after first initialization step with the first slave device (Device_1) frame sync switch 12A closed.

Step C (and consecutive steps): The next device in the sequence (Device_2 in this case) that has not yet assigned itself a DIN receives the next frame sync pulse and assigns itself the next available DIN, and sends through the data bus 10C a message (DIN Update) to devices yet without an assigned DIN to increment their device number counters by one. The frame sync switch 12A is closed by the logic 12C at or soon after the falling (or rising) edge of the frame sync pulse on the frame sync line 10A.

As can be appreciated, in this case the Device_2 was previously instructed to increment its device number counter 12B by Device_1, and thus its DIN at this time may have the value of one (assuming that Device_1 assigned itself an initial DIN value of zero). Any subsequent Devices in the remaining portion of the ring will then increment their DIN respective counter 12B to a value of two, and then to three, etc., depending on how many DIN Update commands that they receive through the data bus 10C. It should be clear that when a particular device receives the frame sync signal on line 10A, it effectively freezes the current value of the DIN storage (e.g., counter or register 12B) and uses this value as the device's bus 10 address or identification value, while instructing a next device or devices to increment their respective DIN register values. Of course, the DIN values can be incremented by any desired amount (e.g., by one, or two, or 10₁₆), and can be expressed in any suitable format (e.g., decimal, BCD, hexadecimal, etc.)

Step D (final step): The Master (Device_0) receives a frame sync pulse in its frame sync input 10A (from the last device in the sequence) and the associated logic 12C in this case determines that the initialization sequence is completed. The Master device may also include the switch 12A if more than one device can assume bus mastership. If not, then the switch 12A is not needed by the (dedicated) Master device. FIG. 5 shows the final state of the bus 10, with all slave device frame sync switches 12A closed, and the Master frame sync switch open.

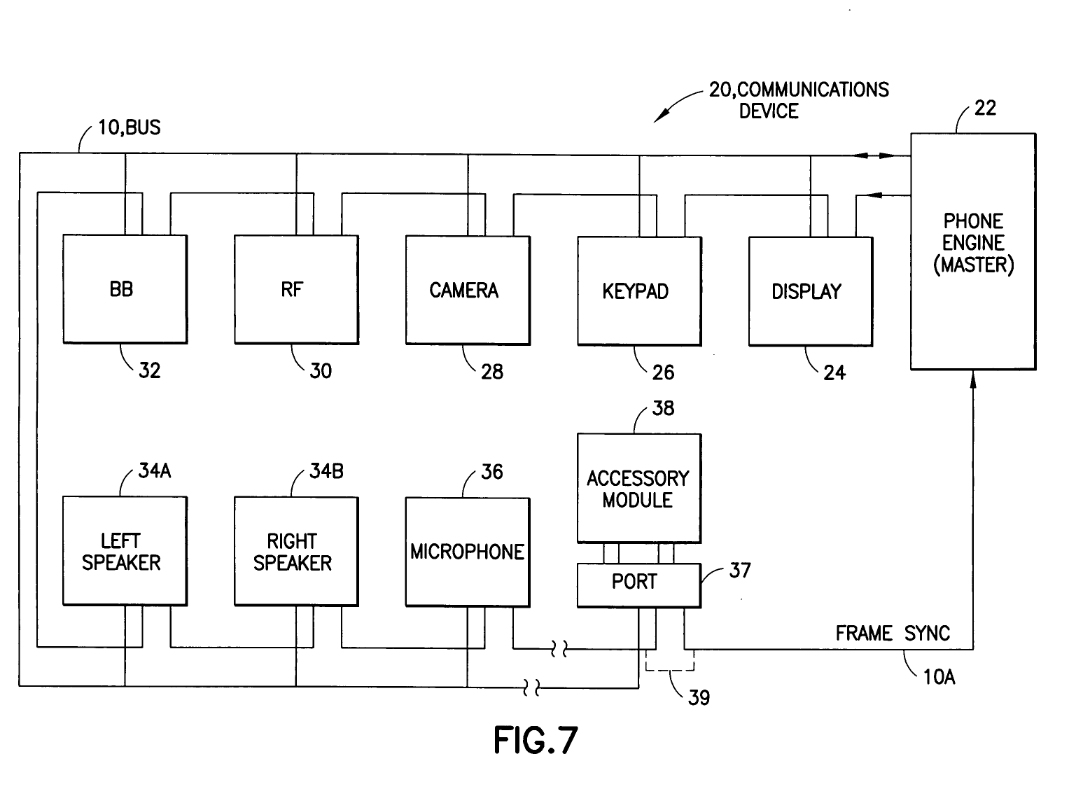

FIG. 7 is a non-limiting example of the use of this invention in a wireless communications device 20 that is constructed and operated in accordance with the embodiments of this invention. The wireless communications device 20 may be a cellular telephone, a personal digital assistant (PDA) having wireless communication capabilities, a portable computer having wireless communication capabilities, an image capture device such as a digital camera having wireless communication capabilities, a gaming device having wireless communication capabilities, a music storage and playback appliance having wireless communication capabilities, an Internet appliance permitting wireless Internet access and browsing, as well as portable units or terminals that incorporate combinations of such functions. Of course, non-wireless devices may also benefit from the teachings of this invention, whether they be portable devices or generally non-portable devices, as may devices that are not primarily intended as communication devices (as non-limiting examples, medical instruments, computer peripheral devices and scientific measuring and analysis instruments).

In the example of FIG. 7 the role of the Master is assumed by a Phone Engine 22, typically a stand-alone data processor or one integrated with other components in an ASIC or other type of large scale integration device (an integrated circuit chip). If the latter, then the bus 10 may be wholly or partly contained within the chip. Coupled to the bus 10 are a plurality of wireless device units and peripheral devices such as, but not limited to, a display unit 24, keypad unit 26, a digital camera: unit 28, an RF unit 30, a baseband (BB) unit 32, first and second speaker units 34A, 34B and a microphone unit 36. Each of the units 24, 26, 28, 30, 32, 34 and 36 is assumed to include circuitry along the lines shown in FIG. 2, and thus contain the switch 12A, the DIN register 12B and the logic 12C. For a device already containing intelligence (e.g., a microprocessor or a microcontroller), the function of the logic 10C can be performed by the native controller or processor. The Phone Engine 22 (Master) is constructed along the lines shown in FIGS.3-5. If no other unit is capable of assuming bus mastership then the switch 12A may be eliminated from the Phone Engine 22, as may the DIN register 12B. Note that there may be a port 37 for coupling to one or more external detachable accessory modules 38, each of which preferably is also configured and operated in the manner shown in FIGS. 2-6. If an external module 38 is not attached then preferably there is a pass-through 39 for the frame sync line 10A to ensure that it is not left in an open state. In a given embodiment a particular Phone Engine may be capable of supporting multiple multi-drop buses 10, not just the one shown.

There are a number of advantages that are realized by the use of the exemplary embodiments of this invention. One significant advantage relates to the improvement that is achieved, as compared to conventional approaches, in that unique, application-dependent identification of multiple devices on a multi-drop bus can be obtained without a need to provide for factory-programmable identity numbers, single-purpose identity pins, and similar techniques. The avoidance of factory-programmable identity numbers is important for mass production, after-market repairs, etc., as there is no need for the system software to be aware of individual device numbers, as the device identity is defined based solely on the physical location of the device relative to the Master. This is particularly important if the bus 10 is used to connect to, as examples, loudspeakers, microphones, UI devices, sensors, etc., when there may be several similar or identical devices built into the wireless communications device 20 (such as the loudspeakers 34, microphone(s) 36 for left and right channels, acceleration sensors for sensing accelerations along a plurality of orthogonally aligned axes, etc.).

The disclosed topology provides data transfer without additional delay as in a multi-drop bus, and has few fundamental limitations for the number of devices (frame sync signal attenuation and overall propagation delay being parameters of interest in this regard). The effect on overall device complexity is low. The additional power consumption required to implement the embodiments of this invention in standby is low.

Robustness against switch 12A failures (which are typically most likely to result in an open switch) may be provided by implementing the switch 12A as a pull-down for a resistor. Redundant switches may be connected in parallel as well, so that at least one remains operational in the event of a stuck-open failure of another.

Based on the foregoing description it can be appreciated that there has been disclosed a method, an apparatus and a computer program product to assign different identification values to a plurality of devices coupled to a bus 10, comprising detecting a change of state, such as an edge, of a signal that occurs in a signal line (e.g., frame sync 10A) in a first device (e.g., Device_1), assigning to the first device an identification value based on a current value in a first device identification storage 12C, sending a command to the next device (e.g., Device_2), and any other devices (e.g., Device_3) connected to the bus, to increment the current value of their respective device identification storage; and closing a first device switch 12A for coupling another occurrence of the signal to a next device of the plurality of devices.

In the foregoing description of the exemplary of this invention it is noted that at least some of the steps may be executed in a different order, such as by closing the device switch 12A prior to sending the DIN Update command on the data bus 10C.

It should be appreciated that the logic 12C may be embodied in whole or in part as a digital data processor that operates in accordance with a stored computer program to execute the operations described above, including detecting the change of state of the signal that occurs in the signal line 10A; assigning to the associated first device 12 an identification value based on a current value in a first device identification storage 12B; sending the command to a next device, and any other devices, connected to the bus 10, to increment a current value of their respective device identification storage; and closing the switch 12A in the first device 12 for coupling another occurrence of the signal to the next device of the plurality of devices.

In general, the embodiments of this invention may be implemented by computer software executable by a data processor, or by hardware, or by a combination of software and hardware. Further in this regard it should be noted that the various blocks of the logic flow diagram of FIG. 6 may represent program steps, or interconnected logic circuits, blocks and functions, or a combination of program steps and logic circuits, blocks and functions. Any data processor that may be used may be of any type suitable to the local technical environment, and may include one or more of general purpose computers, special purpose computers, microprocessors, digital signal processors (DSPs) and processors based on a multi-core processor architecture, as non-limiting examples.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the invention. However, various modifications and adaptations may become apparent to those skilled in the relevant arts in view of the foregoing description, when read in conjunction with the accompanying drawings and the appended claims. As but some examples, the use of other similar or equivalent signal lines, types of devices, numbers of devices and the like may be attempted by those skilled in the art. However, all such and similar modifications of the teachings of this invention will still fall within the scope of the embodiments of this invention.

It should be noted as well that the above description assumes the use of a synchronous multi-drop bus 10 and provides the clock signal 10B to synchronize the transfer on the data bus 10C of the increment command sent from one device 12 to the next. However, the embodiments of the invention may used as well for asynchronous buses.

It should be noted as well that in the disclosed embodiments the frame sync signal 10A operates in a manner analogous to a word clock or word sync signal, however the term “frame” is preferred as being more general and, in fact, a given frame may convey variable word-width data unit across the data bus 10C. However, the exemplary embodiments are not limited for use with a frame or word synchronization signal as the signal coupled to the switches 12A, and any other suitable bus signal line, such as one of the data lines 10C (e.g., one not used to convey the DIN Update signal), may be used as well as the signal coupled to the switches 12A.

Furthermore, some of the features of the exemplary embodiments of this invention may be used to advantage without the corresponding use of other features. As such, the foregoing description should be considered as merely illustrative of the principles, teachings and embodiments of this invention, and not in limitation thereof.

What is claimed is:

1. A method to assign different identification values to a plurality of devices coupled to a bus, comprising:
detecting a change of state of a signal that occurs in a signal line in a first device;
assigning to the first device an identification value based on a current value in a first device identification storage;
sending a command to a next device, and other devices of the plurality of devices coupled to the bus, to increment a current value of their respective device identification storage; and
closing a switch in the first device for coupling another occurrence of the signal to the next device of the plurality of devices.

2. The method as in claim 1, where the bus comprises a multi-drop bus, and where the switch of the first device and switches of others of the plurality of devices selectively configure at least one bus signal line initially from a ring bus configuration to the multi-drop bus configuration.

3. The method as in claim 1, embodied in a wireless communications device.

4. The method as in claim 1, where the signal normally operates as a frame synchronization signal.

5. The method as in claim 1, where the signal is sourced from a master device coupled to the bus, and where receipt of the signal by the master device through a closed switch of the last device of the plurality of devices indicates that assigning of different identification values is completed.

6. A method as in claim 1, where the current value in the first device identification storage is a reset value, and where a final value of the device identification storage of another device of the plurality of devices is incremented from the reset value a number of times that is a function of a number of devices disposed between the another device and the first device.

7. A method as in claim 1, where a final value in the device identification storage of each device is a function of a number of devices disposed along the bus between that device and a master device.

8. A device, comprising:
means for detecting a change of state of a signal that occurs in a signal line input to the device from a bus;
means for assigning to the device an identification value based on a current value contained in device identification storage;
means for sending a command to a next device and to other devices coupled to the bus, the command being one to increment a current value of a respective device identification storage; and means for coupling another occurrence of the signal to a corresponding detecting means of the next device.

9. The device as in claim 8, where the bus comprises a multi-drop bus, and where the coupling means of the device and corresponding coupling means of others of the devices selectively configure the bus signal line initially from a ring bus configuration to the multi-drop bus configuration.

10. The device as in claim 8, embodied in a wireless communications device.

11. The device as in claim 8, where the signal normally operates as a frame synchronization signal.

12. The device as in claim 8, where the signal is sourced from a master device coupled to the bus, where the device is a first device of a plurality of devices, and where receipt of the signal by the master device through a coupling means of a last device of the plurality of devices indicates that assigning of different identification values is completed.

13. A device as in claim 8, where the current value in the first device identification storage is a reset value, and where a final value of the device identification storage of another device of the plurality of devices is incremented from the reset value a number of times that is a function of a number of devices disposed between the another device and the first device.

14. A device as in claim 8, where a final value in the device identification storage of each device is a function of a number of devices disposed along the bus between that device and a master device.

15. The device as in claim 8, embodied in an integrated circuit.

16. The device as in claim 8, where at least said device and at least a portion of the bus are embodied in an integrated circuit.

17. A computer program product embodied on a computer readable medium, execution of said computer program product by a processor resulting in operations comprising assigning different identification values to a plurality of devices coupled to a bus, comprising detecting a change of state of a signal that occurs in a signal line in a first device; assigning to the first device an identification value based on a current value in a first device identification storage; sending a command to a next device and other devices, of the plurality of devices coupled to the bus to increment a current value of their respective device identification storage; and closing a switch in the first device for coupling another occurrence of the signal to the next device of the plurality of devices.

18. A computer program product as in claim 17, where the bus comprises a multi-drop bus, and where the switch of the first device and switches of others of the plurality of devices selectively configure at least one- bus signal line initially from a ring bus configuration to the multi-drop bus configuration.

19. A computer program product as in claim 17, embodied in a wireless communications device.

20. A computer program product as in claim 17, where the signal normally operates as a frame synchronization signal.

21. A computer program product as in claim 17, where the signal is sourced from a master device coupled to the bus, and where receipt of the signal by the master device through a closed switch of the last device of the plurality of devices indicates that assigning of different identification values is completed.

22. A computer program product as in claim 17, where the current value in the first device identification storage is a reset value, and where a final value of the device identification storage of another device of the plurality of devices is incremented from the reset value a number of times that is a function of a number of devices disposed between the another device and the first device.

23. A computer program product as in claim 17, where a final value in the device identification storage of each device is a function of a number of devices disposed along the bus between that device and a master device.
